(19) United States
(12) Patent Application Publication
(10) Pub. No.: US 2007/0256541 A1
(43) Pub. Date: Nov. 8, 2007

(54) Musical video game console and methods therefor

(76) Inventor: Jack J. McCauley, Danville, CA (US)

Correspondence Address: CHRISTIE, PARKER & HALE, LLP, PO BOX 7068, PASADENA, CA, 91109-7068, US

(21) Appl. No.: 11/418,374

(22) Filed: May 4, 2006

(51) Int. Cl. G10H 1/00

(52) U.S. Cl. 84/600

(57) ABSTRACT

A game console capable of operating with a variety of electronic musical instruments is provided. Such a system is especially useful for downloading different musical video games for a variety of musical instruments and capable of changing the level of difficulty during play. In one embodiment, the electronic musical instrument includes a positional sensor which can be one or more of a solid state gyroscopic sensor, a magnetic compass sensor and an accelerometer. The position of the electronic musical instrument can be used by the game console to select from two or more strategy files or to change the level of play difficulty. The game console has a network connection for sharing player responses with other remote players, and can also be used to download new musical and strategy files.

### BACKGROUND OF THE INVENTION

The present invention relates to video game systems. More particularly, the present invention relates to a flexible musical video game console having access to online musical games for different instruments and with varying difficulty.

Computer video games have evolved from the early games, such as “pong”, a black-and-white two-dimensional game on an eight-bit personal computer, to the present day sophisticated games with color three-dimensional video games on a dedicated game console.

Popular video games include musical video games wherein a player interacts with music by stepping on a dance pad coupled to a game console. The objective of the musical game is to step on a plurality of the predetermined positions on the dance pad synchronously with a sequence of visual cues displayed on a video screen. Points are awarded based accuracy, speed and level of difficulty. For simplicity, most musical video game content is stored on a DVD which is loaded into the game console prior to beginning the game. The player selects a song from the DVD, selects the level of difficulty, and then proceeds with the musical game.

After repeatedly playing the same songs over and over again from the DVD-based musical video game system, most players soon get bored because they are unable to select new songs that have not been included on the DVD's song list. Hence there is a need for an improved musical game console which supports different musical instruments, supports changing difficulty while playing, and also enables one or more players to download a wide variety of online musical video games, and enables players to interact with other players musically.

### SUMMARY OF THE INVENTION

To achieve the foregoing and in accordance with the present invention, a game console capable of operating with a variety of electronic musical instruments is provided. Such a system is especially useful for downloading different musical video games for a variety of musical instruments and capable of changing the level of difficulty during play.

In one embodiment, the electronic musical instrument includes a positional sensor capable of detecting the absolute and relative position of the electronic musical instrument. The positional sensor can be one or more of a solid state gyroscopic sensor, a magnetic compass sensor and an accelerometer.

The musical instrument also includes an output port for sending the position of the electronic musical instrument to the game console. The position of the electronic musical instrument can be used by the game console to select from two or more strategy files. The two or more strategy games can vary in difficulty or be for different musical instruments.

Many variations are possible. For example, the game console has a network connection for sharing player responses with other remote players, enabling the players to interact during the musical game. The network connection can also be used to download new musical and strategy files.

Note that the various features of the present invention can be practiced alone or in combination. These and other features of the present invention will be described in more detail below in the detailed description of the invention and in conjunction with the following figures.

### BRIEF DESCRIPTION OF THE DRAWINGS

The present invention is illustrated by way of example, and not by way of limitation, in the figures of the accompanying drawings and in which like reference numerals refer to similar elements and in which:

FIG. 1 is a block diagram showing one embodiment of a musical game console coupled to a game device in accordance with the present invention.

FIG. 2 is a flow diagram illustrating the operation of the musical game console of FIG. 1.

FIG. 3 is a flow diagram illustrating in greater detail the MIDI Sync Interrupt of FIG. 2.

FIGS. 4, 5 and 6 illustrate musical and strategy tracks for a string instrument, a percussion instrument and a pressure pad, respectively.

FIG. 7 illustrates the various files descriptors for the corresponding tracks.

FIG. 8 shows an example of a string instrument.

### DETAILED DESCRIPTION OF THE PREFERRED EMBODIMENTS

The present invention will now be described in detail with reference to a few preferred embodiments thereof as illustrated in the accompanying drawings. In the following description, numerous specific details are set forth in order to provide a thorough understanding of the present invention. It will be apparent, however, to one skilled in the art, that the present invention may be practiced without some or all of these specific details. In other instances, well known process steps and/or structures have not been described in detail in order to not unnecessarily obscure the present invention. The features and advantages of the present invention may be better understood with reference to the drawings and discussions that follow.

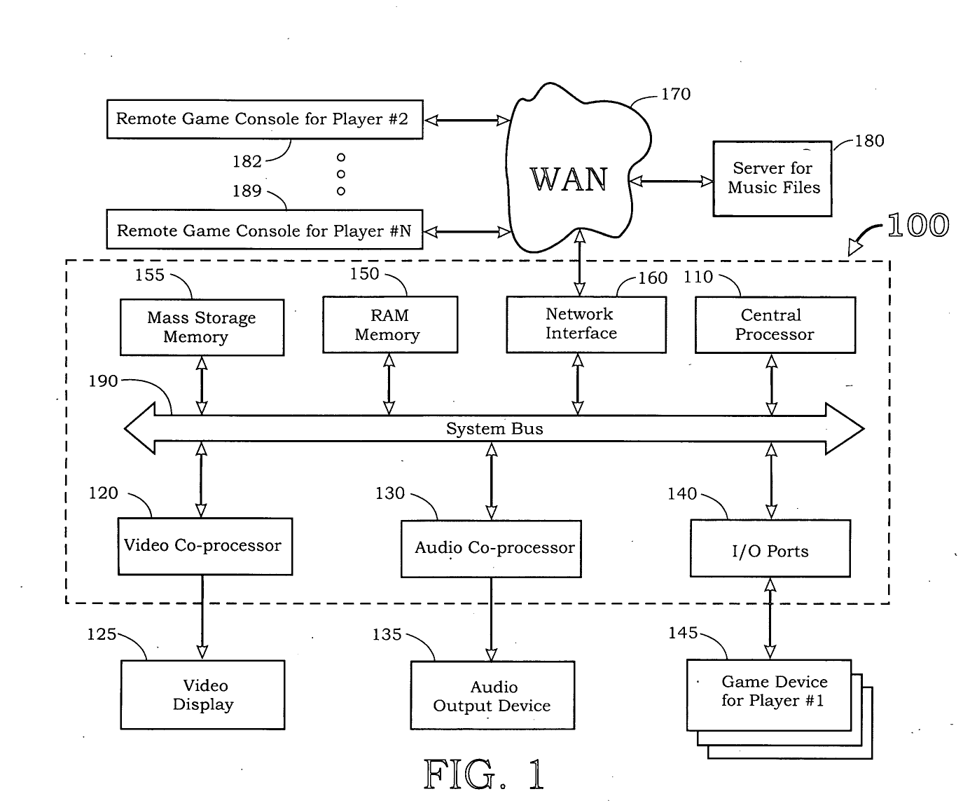

To facilitate discussion, FIGS. 1-8 include block diagrams and flow diagrams which illustrate the operation of one embodiment of the game console in accordance with the present invention.

Referring now to FIG. 1, a musical game console 100 includes central processor 110, video co-processor 120, audio co-processor 130, input/output ports 140, RAM memory 150, mass storage memory device 155, and network interface 160, coupled to each other via system bus 190. Game console 100 can be a dedicated game console such as a Sony PlayStation 2, a Nintendo Game Cube, Microsoft X-Box or an arcade cabinet, or can be a general purpose computer such as a Dell desktop computer.

In this embodiment, video co-processor 120 is coupled a video display device 125, e.g. a flat screen video monitor, while audio co-processor 130 is coupled to an audio output device, e.g. a speaker or a headphone. Game console 100 can also coupled via network interface 160 to a remote music file server 180 and one or more remote game player 182 . . . 189 via a wide area network 170 such as the Internet.

One or more musical game players can interact with game console 100 via one or more game devices, e.g., game device 145, which can be a string instrument such as a guitar, a percussion instrument such as a drum set, or a pressure device such as a dance pad.

In accordance with the invention, game console 100 includes an operating system (OS) which supports a musical game program (MGP) executing on central processor 110. The OS provides the MGP with system calls for controlling video co-processor 120, audio co-processor 130, input/output ports 140, RAM memory 150, mass storage device 155, and network interface 160.

As will be discussed in greater detail below, instead of an executable file with strategy files predefined for a particular musical instrument, the MGP is a general purpose musical strategy game program which can retrieve or download video and audio primitives, including venue primitives, player render primitives, input device render primitives, note chart render primitives, music audio tracks and timing primitives via network interface 160 or mass storage device 155 such as a DVD player.

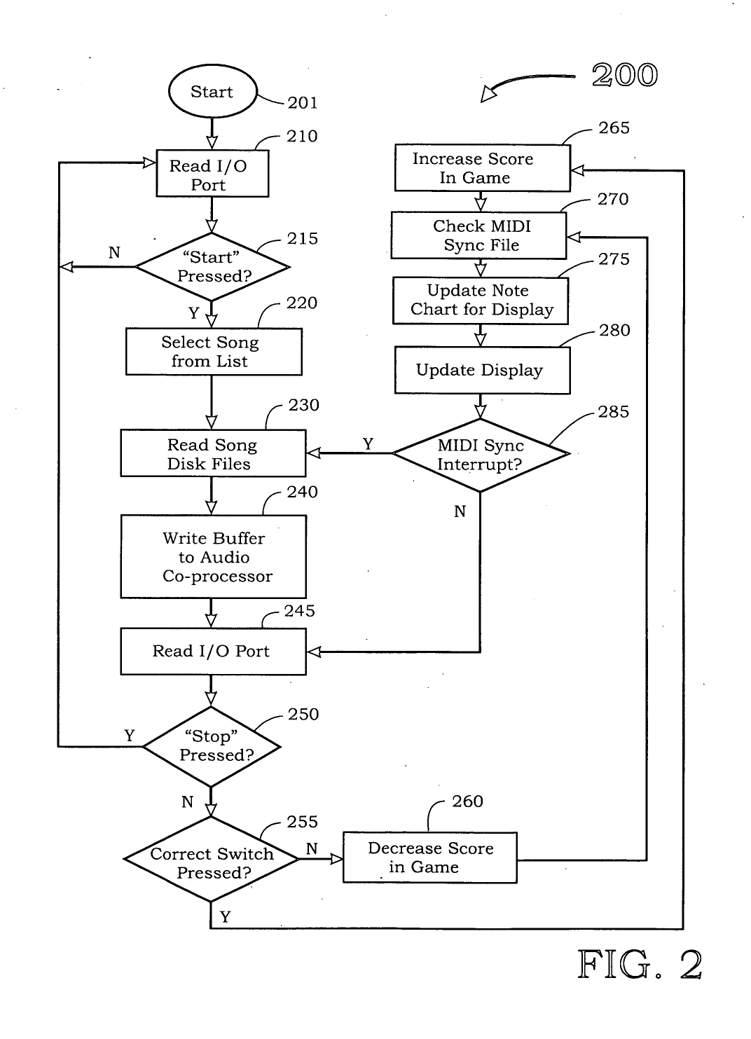

Referring to the flowchart of FIG. 2, when the player is ready to begin the musical game, the MGP detects the “Start” button being depressed (steps 210, 215). Next in step 220, the player selects a song from a dynamic song list. In this embodiment, the MGP retrieves the files associated with the selected song from the local mass storage device 155 or downloads the files associated with the selected song from an external source such as remote music server 180.

The MGP includes a Control Engine Master File (ECF) for selecting the component files associated with the selected song in step 230 which is described in further detail below. Accordingly, the MGP is an executable control program with an ECF having a sequence list of pointers to graphic scenes rendered images.

The appropriate block of audio data is written to the input buffer of audio co-processor 130 (step 240). The song continues until either the selected song ends or console 100 detects that the “Stop” button has been depressed (step 250).

The player can now be scored and if the correct pressure switch, key or button of game device 145 is depressed within the appropriate time window (step 255), the player is rewarded with an increase in his or her game score (step 265). The video display 125 can also provide a visual reward such as a “happy face” or a happy character jumping for joy.

Conversely, if the incorrect pressure switch, key or button is depressed or if the timing of the depression is incorrect, then the player's game score is decreased (step 260). An appropriate “sad face” can be shown on video display 125.

In steps 270, 275, the MGP executing on central processor 110 checks the MIDI (Music Industry Digital Interface) Sync file for synchronization information and updates the Note Chart for display device 125. Central processor 110 sends the appropriate video data to video co-processor 120 thereby updating the output of video display 125.

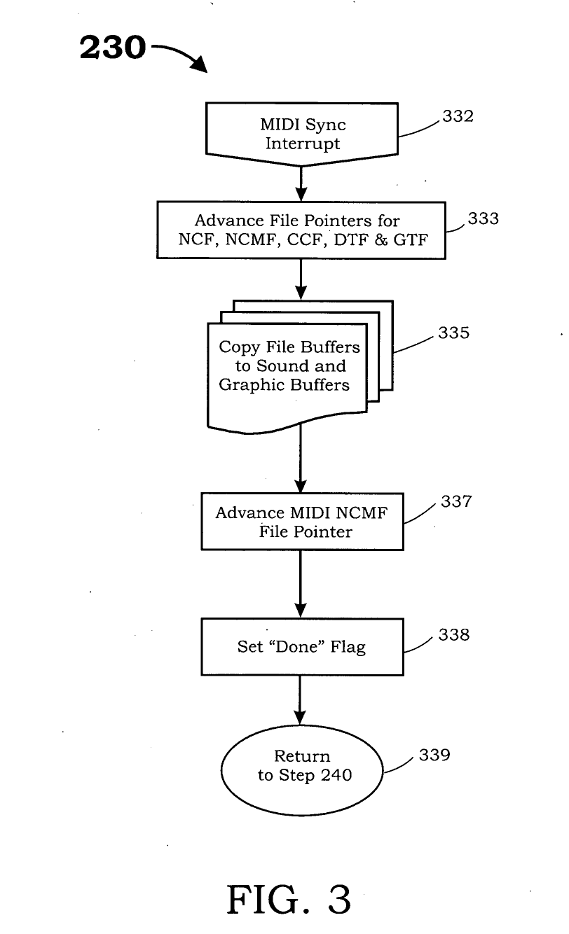

Referring also to FIG. 3 which elaborates step 230 of FIG. 2, in the event of a MIDI Sync interrupt (step 285), the MGP advances the file pointers into the NCF (Note Chart File), the MIDI NCMF (Note Chart Master File), the CCF (Video Primitive File), the Drum Track File (DTF) and the Guitar Track File (GTF) (step 333).

Appropriate segments of these files are copied to the respective input buffers of video co-processor 120 and audio co-processor 130 (step 335). In steps 337, 338, the MIDI NCMF file pointer is then advanced to the next sequence and the “Done” flag is set. As shown in FIGS. 2, 3, the process is repeated until the song ends or the player depresses the “Stop” button on console 100.

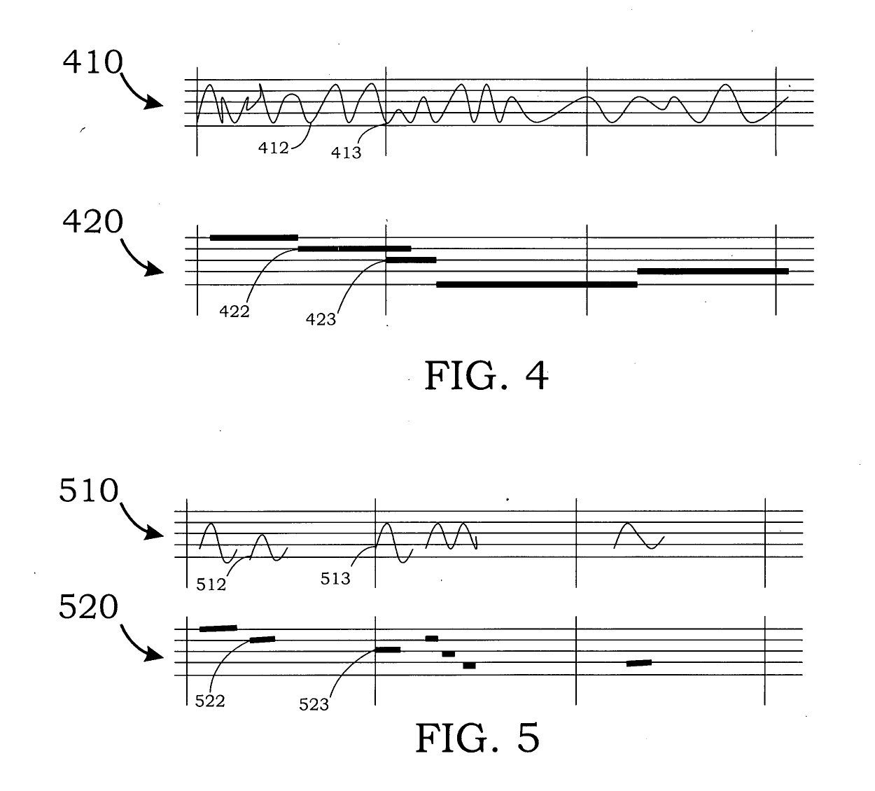

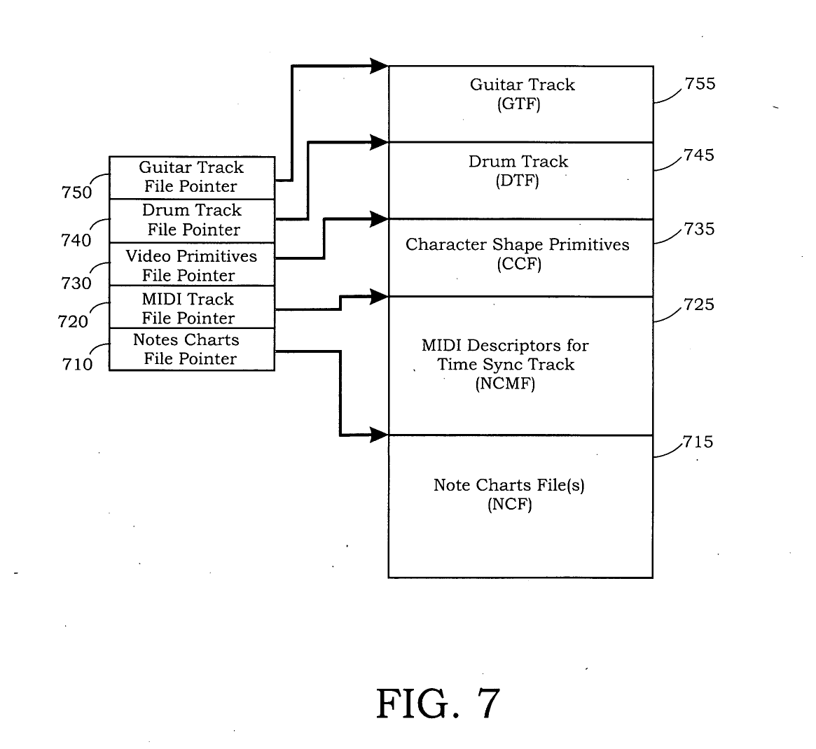

Referring also to the exemplary tracks of FIGS. 4, 5, 6, and the file and file pointer structure of FIG. 7, the delivery of synchronized primitives stored in various files of the Musical Game Program (MGP), in this embodiment, the NCF 715, the MIDI NCMF 725, the CCF 735, the DTF 745 and the GTF 755, to provide the appropriate audio and video feedback to the player via audio device 135 and video display 125, is now described in greater detail.

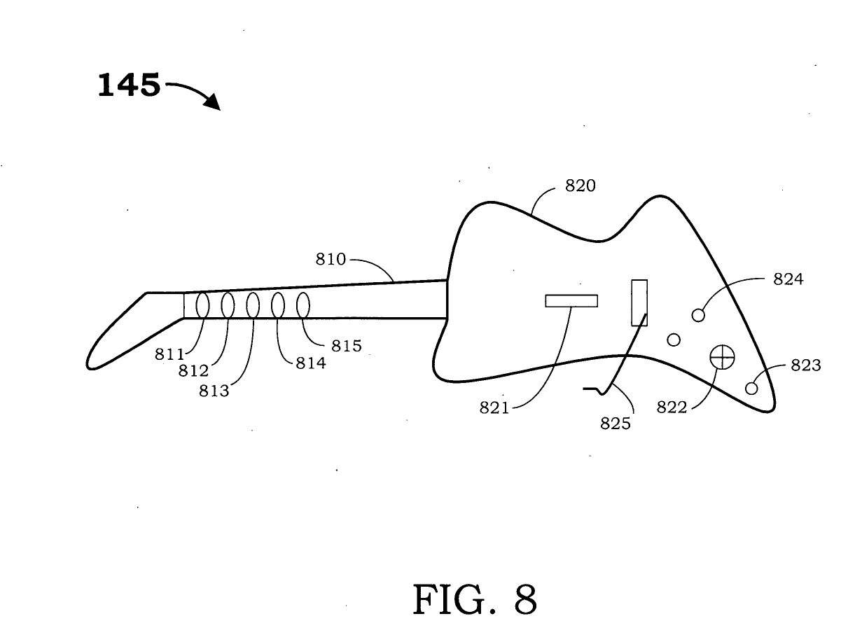

FIG. 4 includes a musical track 410 and a strategy track 420 for a typical string instrument such as guitar 145 of FIG. 8. The player depresses keys 811, 812, 813, 814, 815 located on guitar neck 810 in response to visual cues on video display 125. The player may also be required to “strum” paddle 821 on guitar body 820. For example, when the note 412 begins playing on audio device 135, strategy file cue 422 is outputted to video display 125. Similarly, when the note 413 begins playing on audio device 135, strategy file cue 423 is outputted to video display 125.

In some embodiments, the difficulty of the musical game can also be increased by detecting “key velocity”, e.g., how hard keys 811, 812, 813, 814, 815 are depressed, and/or allowing the player to vary the pitch of the note by “bending” guitar neck 810. It is also possible for dance pads to sense a range of different pressures and for the MGP to provide corresponding levels of play depending on the pressure.

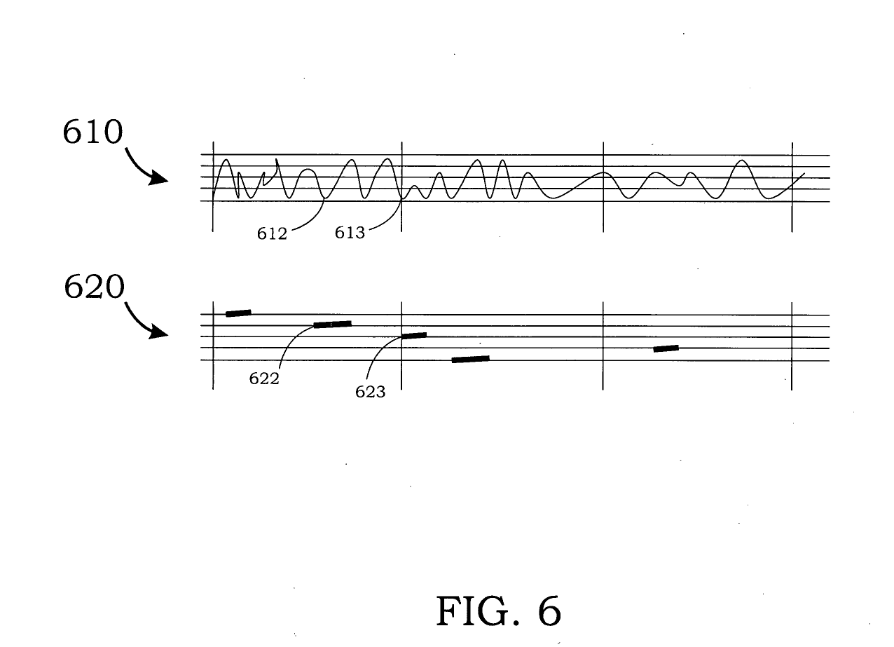

Similarly, FIGS. 5 and 6 show the respective musical tracks 510, 610 and respective strategy tracks 520, 620 for a percussion instrument such a drum set and a pressure sensing system such as a dance pad. Accordingly, the MGP executing on game console 100 is able to adapt to different instruments depending on the respective musical and strategy tracks.

In accordance with another aspect of the present invention, game device 145, e.g., a guitar also includes incremental position and/or motion sensor(s) to detect the absolute and/or relative position and/or movement of a guitar or a dancer, and display a corresponding image on video display 125. Suitable position/motion sensors include commercially available solid state gyroscopic sensors, magnetic compass sensors and accelerometers from www.freescale.com, www.ssp.co.ip and www.pnicorp.com.

Accordingly, position and motion sensing by game device 145 is accomplished by relying on the piezo coriolis effect of gyroscopic sensors, wherein the solid state gyroscope yields angular position relative to the angle at which game device 145 is rotated. For instance, the output voltage from the sensor can be a function of dw/dt, and wherein “w” is the relative angular position of game device 145 during rotation.

Position sensing can also be accomplished by using the true north detection capability of magnetic compass sensors, e.g., the output voltage is a function of sin(Mnorth(w)), and wherein “w” is the angle between true magnetic north and the angle at which game device 145 is being held.

It is also possible to use the gravitational field direction and plane-of-earth orientation capabilities of accelerometers for position sensing. One such position sensor might be a commercially available MEMS (micro-machined silicon) sensing accelerometer. Such accelerometers provide the vertical position of game device 145 as a function of the earth gravitational field. For example, the voltage output can be a function of angular position orthogonal relative to the earth's surface, i.e., Vout is a function of sin(w) and wherein “w” is the angular position of game device 145 relative to the ground plane.

The positional sensor can also be a simple switch device which yields the rotated angle in crude but discernable increments. One exemplary impulse function for switch is Vout=3.3V*I(w), wherein “w” is the angle of game device 145 relative to the ground.

In addition to displaying the position of game device 145, positional information detected from game device 145 can also be used for a variety of non-positional controls, including volume control and note bending to vary change pitch. The position of game device 145 can also be used to select different strategy files and/or to control the level of difficulty. Accordingly, the player can select from base guitar track, lead guitar track, rhythm guitar track, speed of music, mode of game (solo, duet) or to change songs while playing, by for example, rotating the guitar body 90 degrees from the normal playing position such that the guitar neck is almost vertical, the player can switch musical tracks to from base guitar to lead guitar without interrupting the selected song.

Although the above exemplary description uses protocols such as MIDI files, it is possible to use other protocols known to one skilled in the art. In addition, the functionality of game console 100 and game device 145 can be in software, firmware, hardware or combinations thereof.

Advantages of the present invention include the ability to download add-on or enhancement to an existing musical game, a new song for an existing musical game, or a completely new game with a new list of songs. Players can also trade musical games among friends or preview trial versions of musical games before purchasing. The ability to change the level of play difficulty and/or to switch tracks during play also makes the musical games more entertaining.

Many modifications and additions to the present invention also possible. For example, multiple players can play synchronously on a single console 100. Alternatively, multiple players can play synchronously one console 100 and one or more remote game console(s) 182 . . . 189. The multiple players can be on similar instruments such as a lead guitar, a rhythm guitar and a base guitar, or on different instruments such as a guitar, a drum set and a dance pad. In addition, the players can interact cooperatively or competitively.

While this invention has been described in terms of several preferred embodiments, there are alterations, modifications, permutations, and substitute equivalents, which fall within the scope of this invention. It should also be noted that there are many alternative ways of implementing the methods and apparatuses of the present invention. It is therefore intended that the following appended claims be interpreted as including all such alterations, modifications, permutations, and substitute equivalents as fall within the true spirit and scope of the present invention.

1. A method for controlling a game console coupled to an electronic musical instrument, the method comprising:
downloading at least two strategy files into the game console,
detecting a position of the electronic musical instrument; and
selecting one of the at least two strategy files based on the position of the electronic musical instrument.

2. The method of claim 1 wherein the at least two strategy files includes a first difficulty strategy file and a second difficulty strategy file.

3. The method of claim 1 wherein the at least two strategy files includes a first instrumental strategy file and a second instrumental strategy file.

4. The method of claim 1 wherein the detecting of the position of the electronic musical instrument includes detecting absolute and relative positional information.

5. The method of claim 1 wherein the position of the musical instrument is obtained by using a gyroscopic sensor.

6. The method of claim 1 wherein the position of the musical instrument is obtained by using a magnetic compass sensor.

7. The method of claim 1 wherein the position of the musical instrument is obtained by using an accelerometer.

8. The method of claim 1 wherein the position of the musical instrument is obtained by using a switch.

9. The method of claim 1 further comprising sending a player response to the selected strategy file of the at least two strategy files from the game console to a second game console via a wide area network.

10. An electronic musical instrument useful in association with a game console, the electronic musical instrument comprising:
a positional sensor for detecting a position of the electronic musical instrument; and
an output port for sending the position of the electronic musical instrument to the game console, and wherein the position of the electronic musical instrument is used to select one of at least two strategy files.

11. The electronic musical instrument of claim 10 wherein the at least two strategy files includes a first difficulty strategy file and a second difficulty strategy file.

12. The electronic musical instrument of claim 10 wherein the at least two strategy files includes a first instrumental strategy file and a second instrumental strategy file.

13. The electronic musical instrument of claim 10 wherein the positional sensor detects absolute and relative positional information.

14. The electronic musical instrument of claim 10 wherein the positional sensor is a gyroscopic sensor.

15. The electronic musical instrument of claim 10 wherein the positional sensor is a magnetic compass sensor.

16. The electronic musical instrument of claim 10 wherein the positional sensor is an accelerometer.

17. The electronic musical instrument of claim 10 wherein the position of the musical instrument is obtained by using a switch.

18. The electronic musical instrument of claim 10 wherein tie game console includes a network interface configured to send a player response to the selected strategy file of the at least two strategy files from the game console to a second game console via a wide area network.

19. The electronic musical instrument of claim 10 further comprising at least one key capable of sensing at least two pressure levels.

20. A dance pad useful in association with a game console, the dance pad comprising:
at least one pressure sensor configured to sense at least two pressure levels; and
an output port for sending a sensed pressure level from the at least one pressure sensor to the game console, and wherein the sensed pressure level is used to select one of at least two strategy files.

21. A video game apparatus, comprising:
a game device comprising a body portion, a plurality of input devices and a positional sensor, the game device configured to provide input device information from the plurality of input devices and positional information from the positional sensor; and
a game console configured to execute a game program on a processor of tie game console, the game program configured for selection of a music track;
wherein the body portion has a shape of a musical instrument;
wherein the game program is configured to provide visual cues, where the visual cues are based on the selected music track; and
wherein the game program is configured to play sounds representative of different musical instruments based on the positional information.

22. The video game apparatus of claim 21 wherein the game program is configured to load, based on the selected music track, at least one of note chart render information and music track information.

23. The video game apparatus of claim 21 wherein the game program is configured to load, based on the selected music track, at least one of venue information and player render information

24. The video game apparatus of claim 21 wherein the game program is configured to select a music track based on the at least some of the input device information and the positional information.

25. The video game apparatus of claim 21 wherein the input devices comprise one or more keys and a strum paddle, and wherein the game console is configured to provide display information to a display.

26. The video game apparatus of claim 21:
wherein the game program is configured to select a music track based on the at least some of the input device information and the positional information; and
wherein the game program is configured to load the selected music track from at least one of a storage device and a DVD.

27. The video game apparatus of claim 21 wherein the game program is configured to load the selected music track from a remote music server via a network by way of a network interface part of the game console.

28. The video game apparatus of claim 25 wherein the game program is configured to play at least a portion of the selected music track and to provide the visual cues to a display.

29. The video game apparatus of claim 28:
wherein the input device information comprises information indicative of activation by a game player of at least one of the one or more keys and the strum paddle; and
wherein the game program is configured to compare the timing of the input device information and the visual cues to compute a score.

30. The video game apparatus of claim 21 wherein the game program is configured to process at least some of the input device information of the input devices in a manner representative of different devices based on the positional information.

31. The video game apparatus of claim 30 wherein the different devices are different musical instruments.

32. The video game apparatus of claim 21 wherein the positional sensor comprises at least one of a position sensor, a motion sensor, a magnetic compass sensor, a gyroscopic sensor, and an accelerometer.

33. The video game apparatus of claim 27 wherein the network interface is configured to communicate with one or more remote game players.

34. The video game apparatus of claim 33 wherein the network is the Internet.

35. The video game apparatus of claim 21 wherein the game program is configured to process information from a plurality of game devices.

36. The video game apparatus of claim 35 wherein the plurality of game devices comprise a local game device and a remote game device.

37. The video game apparatus of claim 35 wherein the plurality of game devices comprise a first game device played by a first game player and a second game device played by a second game player.

38. The video game apparatus of claim 38 wherein the first game device and the second game device are different musical instruments.

39. The video game apparatus of claim 21 wherein the positional information is used for volume control.

40. The video game apparatus of claim 21 wherein the positional information is used for note bending.

41. The video game apparatus of claim 21 wherein the different musical instruments include at least one of a base guitar, a lead guitar, and a rhythm guitar.

42. A method of operating a game system, the method comprising:
receiving input information and positional information;
selecting a music track based on at least one of the input information and the positional information;
loading the selected music track;
playing at least a portion of the selected music track;
displaying visual cues based on the selected music track;
providing audio feedback in response to the input information and the positional information; and
displaying visual feedback in response to the input information and the positional information.

43. The method of claim 42 further comprising selecting a game difficulty level based on the positional information of the first electronic musical instrument.

44. The method of claim 42 wherein the loading the selected music track comprises loading information from a remote music server via a network.

45. The method of claim 44 wherein the network is the Internet.

46. The method of claim 42 further comprising:
comparing the timing of the input information and the visual cues to compute a score;
wherein the input information comprises information indicative of activation by a game player of at least one of the one or more keys and the strum paddle.

47. The method of claim 42 further comprising processing at least some of the input information of the input devices in a manner representative of different devices based on the positional information.

48. The method of claim 47 wherein the different devices are different musical instruments.

49. The method of claim 42 further comprising generating audio information based on the input information, with the audio information varying based on the positional information.

50. The method of claim 42 wherein the positional information comprises at least one of volume control and note bending.

51. The method of claim 42 wherein the positional information is used to select from different instrument tracks.

52. The method of claim 51 wherein the different instrument tracks comprise at least one of a base guitar track, a lead guitar track, and a rhythm guitar track.

53. The method of claim 42 wherein the positional information is used to modify one or more game options.

54. The method of claim 53 wherein the one or more game options comprise at least one of a speed of music, a solo mode, a duet mode, and a current song playing.

55. A video game system comprising:
a game console including a processor and memory;
a plurality of game devices representative of a plurality of musical instruments, for use by a plurality of players, at least some of which are not the same musical instrument, the plurality of game devices in data communication with the game console;
the processor configured by program instructions to execute a multiple player at the same time game program providing:
selection of a song from a list of songs; writing of audio data corresponding to the selected song; and
scoring based on activation of game device input within a time window.

56. The video game system of claim 55 wherein the plurality of musical instruments include similar instruments.

57. The video game system of claim 56 wherein the similar musical instruments include at least two of a group comprising a lead guitar, a rhythm guitar, and a base guitar.

58. The video game system of claim 55 wherein the plurality of musical instruments include different instruments.

59. The video game system of claim 58 wherein the different instruments include a guitar and a drum set.

60. A video game system comprising:
a plurality of game consoles coupled by a network, each game console including a processor and memory;
a plurality of game devices representative of a plurality of musical instruments, at least some of which are not representative of the same musical instrument, each of the plurality of game devices in data communication with at least one of the game consoles, each of the processors being configured to execute a game program providing writing of audio data corresponding to a song; and
scoring based on activation of game device input within a time window.
